(19) United States
(12) Patent Application Publication
(10) Pub. No.: US 2026/0164510 A1
(43) Pub. Date: Jun. 11, 2026

(54) LIGHT SOURCE UNIT AND OPTICAL HEATING APPARATUS

(71) Applicant: Ushio Denki Kabushiki Kaisha, Tokyo (JP)

(72) Inventor: Yoshimasa IKE, Tokyo (JP)

(73) Assignee: Ushio Denki Kabushiki Kaisha, Tokyo (JP)

(21) Appl. No.: 19/412,229

(22) Filed: Dec. 8, 2025

(30) Foreign Application Priority Data
Dec. 9, 2024 (JP) 2024-214257

(51) Int. Cl. H05B 3/00; H05B 3/26

(52) U.S. Cl. CPC H05B 3/0047; H05B 3/265; H05B 2203/032

(57) ABSTRACT

Providing a light source unit and an optical heating apparatus capable of efficiently heating a semiconductor substrate while suppressing shortening of the lifetime of an LED element. The light source unit includes: a plurality of LED elements; an LED substrate on which the plurality of LED elements are arranged; a lens substrate disposed to face the LED substrate; and a plurality of lens elements formed on the lens substrate at positions corresponding respectively to the LED elements, wherein an LED density, obtained by dividing an effective number of the LED elements located within a first region by an area of the first region, is set between 5 and 15 LEDs/cm², and a ratio, obtained by dividing a length of the lens element corresponding to the LED element by a length of the LED element, is 8.0 or less.

### CROSS-REFERENCE TO RELATED APPLICATIONS

This application claims priority of Japan Patent Application No. 2024-214257, which was filed on Dec. 9, 2024, and which is incorporated herein in its entirety by reference.

### BACKGROUND OF THE INVENTION

### Field of the Invention

The present invention relates to a light source unit that irradiates a semiconductor substrate with heating light to heat the semiconductor substrate, and an optical heating apparatus including the light source unit.

### Description of the Related Art

In a semiconductor manufacturing process, various processes, including film formation, oxidation diffusion, reforming, and annealing, are performed on a semiconductor substrate such as a silicon wafer. In these processes, a heating method of irradiating a main surface of a semiconductor substrate with heating light (hereinafter referred to as “heating light” for convenience) is often adopted because the method enables non-contact processing. The term “main surface” refers to a surface, among those constituting a plate-shaped object, that has a significantly larger area than the other surfaces.

Examples of the light source for heating light include a halogen lamp and a light-emitting diode (LED) element. Among these, an LED element is being adopted due to its ability to raise the temperature of a semiconductor substrate to be heated at a high speed.

The light output of an individual LED element is typically smaller than that of a halogen lamp, for example. Therefore, in order to irradiate the semiconductor substrate with heating light necessary for processing, as described in Patent Document 1 below, a plurality of LED elements are arranged to face the semiconductor substrate.

### PRIOR ART DOCUMENT

### Patent Document

Patent Document 1: JP-T-2018-525813

### SUMMARY OF THE INVENTION

By adopting the LED element as the light source for heating light, the temperature of the semiconductor substrate can be raised at a high speed. Recently, there has been an increasing demand for heat treatment of a semiconductor substrate at a higher temperature while achieving high-speed temperature rise.

In view of the above requirement, it is considered that more LED elements may be mounted in the light source unit of the optical heating apparatus to irradiate the semiconductor substrate with a larger amount of heating light. Specifically, it is considered that the separation distance between individual LED elements may be reduced, and additional LED elements may be disposed. Here, an LED element has the property of having a shorter lifetime when the temperature of the LED element itself rises. Therefore, when more LED elements are mounted and the separation distance between the individual LED elements decreases, the temperature of the LED elements themselves tends to rise, resulting in a shorter lifetime of the LED elements.

That is, when a configuration is adopted in which the separation distance between adjacent LED elements is reduced and LED elements are additionally disposed to increase the heating temperature of the semiconductor substrate, the lifetime of the LED elements is shortened.

Shortening the lifetime of the LED elements means shortening the replacement cycle of the LED elements. Even if the temperature of the semiconductor substrate could be increased, the light source unit would not be practical when frequent replacement of the LED elements is required.

In view of the above circumstances, an object of the present invention is to provide a light source unit and an optical heating apparatus capable of increasing the temperature of a semiconductor substrate while suppressing shortening of the lifetime of an LED element, compared to the related art.

A light source unit according to the present invention is a light source unit that irradiates a semiconductor substrate with light to perform heat treatment on the semiconductor substrate, the light source unit including: a plurality of LED elements that emit the light in a first direction; an LED substrate on which the plurality of LED elements are arranged; a lens substrate disposed to face the plurality of LED elements on the LED substrate with respect to the first direction; and a plurality of lens elements formed in a convex shape on the lens substrate at positions corresponding respectively to the LED elements, each of the lens element being configured to reduce a divergence angle of the light emitted from the corresponding LED element. An LED density is 5 LEDs/cm² or more and 15 LEDs/cm² or less, the LED density being obtained by dividing an effective number of the LED elements located within a first region by an area of the first region, the first region being defined by virtually connecting centers of the plurality of LED elements that face the lens substrate and are adjacent to each other when viewed in the first direction. A ratio, obtained by dividing a length of the lens element corresponding to the LED element by a length of the LED element with respect to a direction parallel to a plane orthogonal to the first direction, is 8.0 or less.

As a method of irradiating the semiconductor substrate with a large amount of heating light to increase the temperature of the semiconductor substrate, it is conceivable to reduce the separation distance between the LED elements that emit the heating light and additionally dispose more LED elements. However, in this method, the temperature of the LED elements tends to increase, leading to shortening of the lifetime of the LED elements. In contrast, the present inventor has studied a configuration in which lens elements are disposed corresponding to the LED elements, thereby irradiating the semiconductor substrate with a larger amount of heating light to increase its temperature. Here, it has been found that, when a plurality of lens elements are arranged in an array corresponding to a plurality of LED elements, interference between adjacent lens elements needs to be taken into consideration. As a result of intensive studies, the present inventor has found that, according to the above configuration, the temperature of the semiconductor substrate can be increased by irradiating the semiconductor substrate with a larger amount of heating light, while the reduction in the lifetime of the LED elements is suppressed, compared to the conventional configuration in which no lens elements are disposed. This will be described in detail later in the section “DETAILED DESCRIPTION OF THE PREFERRED EMBODIMENTS”.

The light source unit may include a support member that is disposed on the LED substrate, extends beyond the LED element with respect to the first direction, and supports the lens substrate. The lens substrate may be fixed to the support member via an adhesive.

According to the above configuration, by fixing the lens substrate to the support member, the lens element can be easily disposed with respect to each LED element. In view of the fact that the temperature around the LED element becomes high due to lighting of the LED element, the adhesive for bonding the lens substrate and the support member preferably has high heat resistance. Suitable adhesives include ceramic-based adhesives.

In the light source unit, each of the lens elements may have a convex shape on a side opposite to the LED element.

From the viewpoint of facilitating incidence of the heating light emitted from the LED element on the corresponding lens element, the separation distance between the LED substrate and the lens substrate is preferably small. According to the above configuration, even when the separation distance between the LED substrate and the lens substrate is small, the lens element can be easily formed, which is suitable. For example, a separation distance between the LED substrate and the lens substrate is preferably 2 mm or less, and more preferably 1 mm or less.

Further, the light source unit may include a plurality of heating groups each including the plurality of LED elements arranged close to each other. In at least one of the heating groups, the LED density may be 5 LEDs/cm² or more and 15 LEDs/cm² or less, and the ratio may be 8.0 or less.

In the light source unit, at least one of the LED elements may be disposed to face a peripheral end portion of the semiconductor substrate.

On the main surface of the semiconductor substrate, the peripheral end portion tends to dissipate heat compared to the central portion. Therefore, when the semiconductor substrate is heated, it is preferable to irradiate the peripheral end portion side with a larger amount of heating light than the central portion side to compensate for heat dissipation at the peripheral end portion. With the LED element facing the peripheral end portion of the semiconductor substrate, a part of the heating light tends to travel in a direction different from that toward the semiconductor substrate, compared to the LED element facing the central portion. According to the above configuration, irradiation of the semiconductor substrate with the heating light emitted from the LED element facing the peripheral end portion is facilitated, which is suitable.

The “peripheral end portion of the semiconductor substrate” may refer to a region on the main surface of the semiconductor substrate where a distance from the end portion is 30% or less of the diameter of the main surface. The central portion of the semiconductor substrate refers to a region located inside the peripheral end portion on the main surface of the semiconductor substrate.

According to the present invention, a light source unit and an optical heating apparatus are provided that are capable of increasing the temperature of a semiconductor substrate while suppressing shortening of the lifetime of an LED element, compared to the related art.

### BRIEF DESCRIPTION OF THE DRAWINGS

FIG. 1 is a side cross-sectional view illustrating a configuration example of an optical heating apparatus;

FIG. 2 is a plan view of the light source unit according to FIG. 1 when viewed in the Z direction;

FIG. 3 is an enlarged view of a part of FIG. 2;

FIG. 4 is an enlarged view illustrating a periphery of LED elements and a lens substrate;

FIG. 5A is a further enlarged view of FIG. 4;

FIG. 5B is a view when FIG. 5A is viewed in the Z direction;

FIG. 6 is a perspective view illustrating another configuration example of a lens element;

FIG. 7 is a diagram illustrating simulation conditions in Verification 1;

FIG. 8 is a view of the lens substrate of FIG. 7 when viewed in the Z direction;

FIG. 9 is a graph illustrating a result of Verification 1;

FIG. 10 is a graph illustrating a relationship between the maximum temperature of the LED and the lifetime of the LED;

FIG. 11 is a graph illustrating a result of Verification 3;

FIG. 12 is a view illustrating a modification of the light source unit, following FIG. 2;

FIG. 13 is an enlarged view of a part of FIG. 12; and

FIG. 14 is a view illustrating another modification of the light source unit, following FIG. 2.

### DETAILED DESCRIPTION OF THE PREFERRED EMBODIMENTS

### First Embodiment

Hereinafter, an embodiment of an optical heating apparatus and a light source unit according to the present invention will be described with reference to the drawings. Note that each of the drawings described below is schematic illustration, and a dimensional ratio or the number of pieces in the drawing do not necessarily coincide with an actual dimensional ratio or the actual number of pieces.

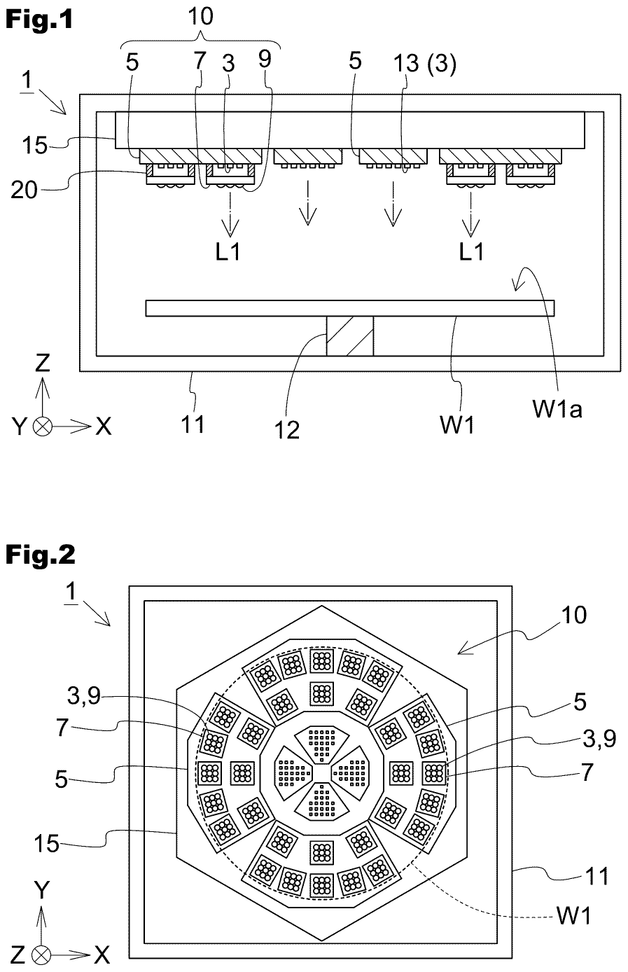

FIG. 1 is a side cross-sectional view illustrating a configuration example of the optical heating apparatus according to the present invention. An optical heating apparatus 1 irradiates a semiconductor substrate W1 with heating light to perform heat treatment on the semiconductor substrate W1. As illustrated in FIG. 1, the optical heating apparatus 1 includes a light source unit 10 that irradiates a semiconductor substrate W1 with heating light, a chamber 11 that accommodates the semiconductor substrate W1, and a support unit 12 that supports the semiconductor substrate W1.

In the following description, an X-Y-Z coordinate system, in which the normal direction of a main surface W1a of the semiconductor substrate W1 is defined as the Z direction and a plane orthogonal to the Z direction is defined as an XY plane, is referenced as appropriate. When positive and negative directions are distinguished at the time of expressing directions, the directions are described with a positive or negative symbol, such as “+X direction” or “−X direction”. When it is not necessary to make a distinction between positive and negative to express a direction, the direction is simply described as “X direction”. That is, in the present specification, when the direction is simply described as “X direction”, both “+X direction” and “−X direction” are included. The same applies to the Y direction and the Z direction.

As illustrated in FIG. 1, the chamber 11 includes the support unit 12 that supports the semiconductor substrate W1 therein. As an example, the support unit 12 is configured to support the semiconductor substrate W1 by a negative pressure generated by a suction mechanism (not illustrated). The configuration of the support unit 12 is not particularly limited as long as the semiconductor substrate W1 can be supported in a state where the main surface W1a is parallel to the XY plane. For example, the support unit 12 may include a plurality of pin-shaped protrusions and support the semiconductor substrate W1 by the protrusions. The support unit 12 may be configured to be able to rotate the semiconductor substrate W1 about an axis normal to the center of the semiconductor substrate W1.

In the present embodiment, the semiconductor substrate W1 is a semiconductor wafer such as a silicon substrate. The diameter of the main surface W1a of the semiconductor substrate W1 is not particularly limited, but as an example, the diameter is set to 300 mm.

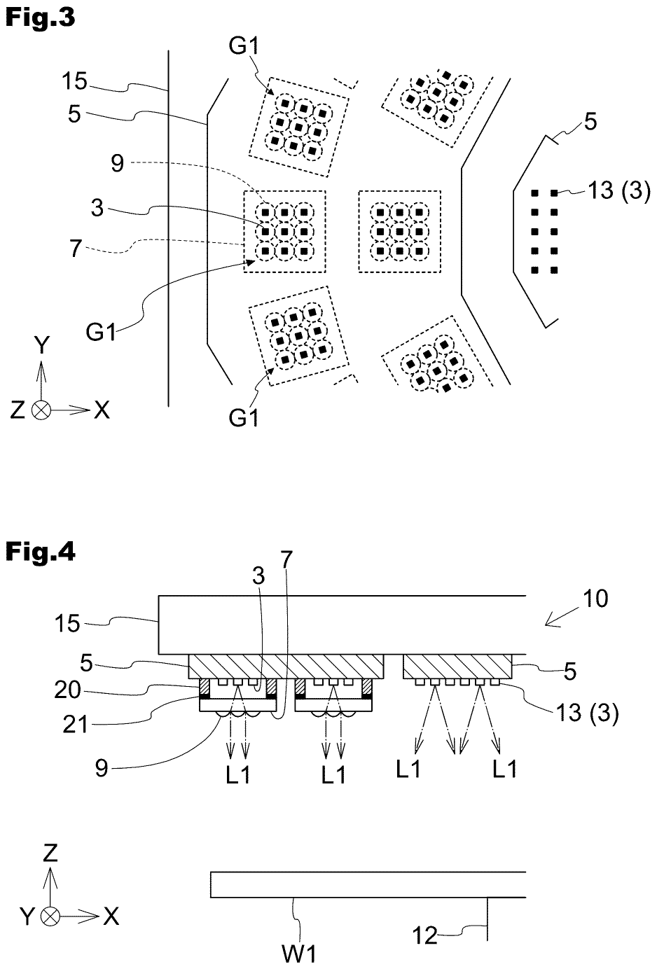

FIG. 2 is a plan view of the light source unit 10 according to FIG. 1 when viewed in the Z direction. In FIG. 2, the position of the semiconductor substrate W1 is schematically indicated by a broken line. FIG. 3 is an enlarged view of a part of FIG. 2. As illustrated in FIGS. 2 and 3, the light source unit 10 includes a plurality of LED elements 3, 3, . . . , an LED substrate 5 on which the plurality of LED elements 3 are arranged, a lens substrate 7 facing the LED substrate 5 with respect to the Z direction, a lens element 9 formed on the lens substrate 7, and a heat sink 15 that supports the LED substrate 5. In FIG. 3, the lens substrate 7 and the lens element 9 are shown transparently and are indicated by broken lines.

The LED substrate 5 is made of, for example, a ceramic material such as aluminum nitride or silicon nitride, and is disposed to extend with respect to the XY plane. The main surface of the LED substrate 5 on the −Z side faces the main surface W1a of the semiconductor substrate W1. As an example, as illustrated in FIG. 1, the LED substrate 5 is disposed on the heat sink 15 and supported by the heat sink 15. The heat sink 15 is made of, for example, a metal material such as copper, stainless steel, or aluminum.

In the present embodiment, as illustrated in FIG. 2, the light source unit 10 includes a plurality of LED substrates 5. This is optional, and one LED substrate 5 may be provided in the light source unit 10.

As illustrated in FIG. 1, the plurality of LED elements 3 emit heating light L1 in the −Z direction. The Z direction corresponds to the “first direction”. As illustrated in FIG. 3, the plurality of LED elements 3 are arranged in a planar arrangement on the main surface of the LED substrate 5. Each LED element 3 is isotropic, for example, and has a quadrangular shape of 1 mm×1 mm when viewed in the Z direction. Typically, the length of the LED element 3 in the X direction is 0.5 mm to 2 mm, and the length in the Y direction is 0.5 mm to 2 mm. The LED element 3 may have a circular shape with a diameter of 1 mm when viewed in the Z direction. When the LED element 3 has a circular shape, its diameter is, for example, 0.5 mm to 2 mm.

In the present embodiment, as illustrated in FIG. 3, the plurality of LED elements 3 are arranged to form a plurality of heating groups G1 on the LED substrate 5. As an example, the heating group G1 includes a plurality of LED elements 3 that are arranged to overlap with one lens substrate 7 when viewed in the Z direction (see FIG. 3). In the present embodiment, for example, the LED substrate 5 located on the −X side includes eight heating groups G1.

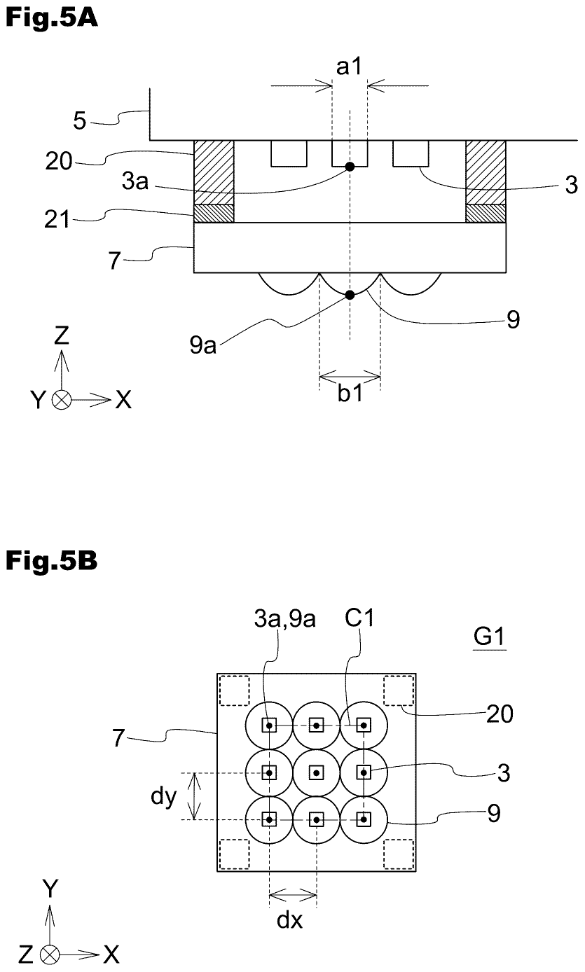

In the heating group G1, the plurality of LED elements 3 may be arranged close to each other. Here, “arranged close to” means that the separation distance between the centers of the LED elements 3 (see also FIG. 5B described later) is five times or less, preferably three times or less, the length of the LED element 3. One lens substrate 7 may be disposed for the plurality of heating groups G1, each of which composed of a plurality of LED elements 3 arranged close to each other.

As an example, the heating light L1 emitted from the LED element 3 has a peak wavelength in a range of 350 nm or more and 450 nm or less.

As illustrated in FIGS. 1 and 3, on the −Z side of the LED substrate 5, the lens substrate 7 is disposed to face the LED substrate 5 with respect to the Z direction. Further, as illustrated in FIG. 3, the lens substrate 7 is disposed to overlap with the plurality of LED elements 3 when viewed in the Z direction, and faces the plurality of LED elements 3. As illustrated in FIG. 3, the light source unit 10 may include the LED substrate 5 on which the lens substrate 7 is not disposed. It is optional whether or not all the LED elements 3 on the LED substrate 5 face the lens substrate 7. That is, as illustrated in FIG. 3, the LED substrate 5 may include an LED element 3 disposed to face the lens substrate 7 and an LED element 3 not disposed to face the lens substrate 7. Hereinafter, from the viewpoint of distinguishing the two, the LED element disposed to face the lens substrate 7 is referred to as “LED element 3”, and the LED element not disposed to face the lens substrate 7 is referred to as “LED element 13”.

The lens substrate 7 is made of, for example, a glass material such as quartz glass, and transmits the heating light L1 emitted from the LED element 3. Here, “transmitting the heating light” may be defined as such that the light transmittance to the heating light L1 is 80% or more.

FIG. 4 is an enlarged view illustrating the periphery of the LED elements 3 and the lens substrate 7. As illustrated in FIG. 4, a plurality of lens elements 9 are formed on the main surface on the −Z side of the lens substrate 7. The lens element 9 is formed corresponding to each LED element 3 (see also FIG. 5B described later). That is, the lens substrate 7 includes a lens element group including the plurality of lens elements 9 corresponding to the heating group G1. In the present embodiment, the lens element 9 has a convex shape on the −Z side. More specifically, the lens element 9 is a convex lens with a spherical surface having a rotator shape centered on a central axis extending in the Z direction. Note that the lens element 9 is not limited to a convex lens having a spherical surface. For example, the lens element 9 may be an aspherical lens.

The curvature of the lens element 9 can be determined, for example, by a simulation in which the lengths a1 of the LED element 3 and b1 of the lens element 9 (see FIG. 5A described later) are kept constant. As a specific example, the curvature of the lens element having the maximum light receiving rate can be adopted in a case where, with the LED element disposed at a separation distance of 80 mm from the semiconductor substrate having a diameter of 20 mm, the curvature of the lens element corresponding to that LED element is varied. Note that the simulation condition is merely an example. When the light receiving rate is defined as 100% in a case where the total light emitted from the LED element is received, the curvature of the lens element may be adopted, for example in view of processing accuracy and the like, in a range in which the light receiving rate is 80% or more, or in a range in which the light receiving rate is 50% or more.

Further, as an example, the length b1 of the lens element 9 (see FIG. 5A described later) is 3 mm to 8 mm, and preferably 4 mm to 6 mm.

FIG. 4 schematically illustrates the mode of traveling of the heating light L1 emitted from the LED element 3. As illustrated in FIG. 4, the heating light L1 emitted from the LED element 3 has a divergence angle and travels while diverging. Here, the lens element 9 reduces the divergence angle of the incident heating light L1 and emits the light. As a result, the heating light L1 emitted from the LED element 3 and directed in a direction different from that toward the semiconductor substrate W1 can be caused to travel toward the semiconductor substrate W1. That is, disposing the lens element 9 to face the LED element 3 enables irradiation of the semiconductor substrate W1 with a large amount of heating light L1.

In particular, in the LED element 3 disposed in a region facing the peripheral end portion of the semiconductor substrate W1, a part of the heating light L1 tends to travel in a direction different from that toward the semiconductor substrate W1. In view of this, as illustrated in the present embodiment, the lens substrate 7 is suitably disposed with respect to the LED element 3 disposed in the region facing the peripheral end portion of the semiconductor substrate W1 (see FIGS. 1 and 2). Here, the “peripheral end portion of the semiconductor substrate W1” may refer to a region on the main surface W1a of the semiconductor substrate W1 where the distance from the end portion is 30% or less of the diameter of the main surface W1a.

FIG. 5A is a further enlarged view of FIG. 4, and FIG. 5B is a view when FIG. 5A is viewed in the Z direction. As illustrated in FIGS. 5A and 5B, in the present embodiment, a vertex 9a of the lens element 9 and a center 3a of the LED element 3 are arranged to coincide when viewed in the Z direction. Here, the coincidence of the vertex 9a of the lens element 9 and the center 3a of the LED element 3 means that the offset between the optical axis of the LED element 3 and the central axis of the lens element 9 is 10% or less, more preferably 5% or less, of the length a1 of the LED element 3. Although the length a1 with respect to the X direction is illustrated in FIG. 5A, the same discussion can be applied with respect to the Y direction.

As illustrated in FIG. 5B, the lens element 9 is preferably formed corresponding to every LED element 3 facing the single lens substrate 7.

As illustrated in FIG. 5A, the lens substrate 7 is fixed to a support member 20 disposed on the LED substrate 5. For example, the lens substrate 7 and the support member 20 are bonded with an adhesive 21.

The support member 20 is preferably made of an insulating material. Examples of the insulating material include a ceramic material such as aluminum nitride and a glass material such as quartz glass. As an example, the support member 20 includes a plate made of aluminum nitride. As illustrated in FIG. 4, the support member 20 extends from the LED substrate 5 beyond the LED element 3 with respect to the Z direction. By fixing the lens substrate 7 to the support member 20, the lens element 9 can be easily disposed with respect to each LED element 3, which is suitable.

From the viewpoint of preventing damage due to contact with the LED element 3, the lens substrate 7 is preferably fixed to a plurality of support members 20 separated from each other, as illustrated in FIG. 5B. That is, according to this configuration, at the time of disposing the support member 20 with respect to the LED substrate 5 on which the LED elements 3 are arranged, the support member 20 can be easily disposed while avoiding the LED elements 3, which is suitable.

The thickness of the support member 20 with respect to the Z direction corresponds to the separation distance between the LED substrate 5 and the lens substrate 7. From the viewpoint of facilitating incidence of the heating light L1 emitted from the LED element 3 on the corresponding lens element 9, the thickness of the support member 20 with respect to the Z direction is preferably 2 mm or less, and more preferably 1 mm or less. Further, from the viewpoint of suppressing collision between the LED element 3 and the lens substrate 7 when the lens substrate 7 is fixed to the support member 20, the thickness is preferably 0.5 mm or more, and more preferably 1 mm or more. In the plurality of lens substrates 7, the thickness of the support member 20 with respect to the Z direction may be different from each other.

From the viewpoint of suppressing collision between the lens element 9 formed on the lens substrate 7 and the LED element 3 when the lens substrate 7 is mounted, the lens element 9 preferably has a convex shape on the side opposite to the LED element 3, that is, on the −Z side.

In view of the fact that the temperature around the LED element 3 becomes high due to lighting of the LED element 3, the adhesive for bonding the lens substrate 7 and the support member 20 preferably has high heat resistance. For example, the heat resistance of the adhesive is preferably 50° C. or higher, and more preferably 100° C. or higher. Suitable adhesives include ceramic-based adhesives.

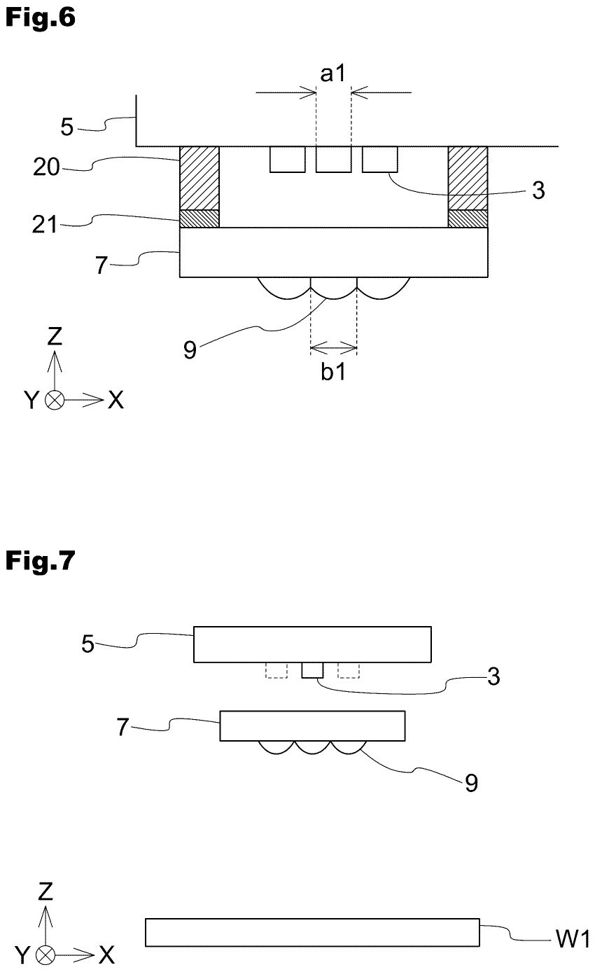

FIG. 5B schematically illustrates a distance dx by which the centers 3a of the respective LED elements 3 are separated from each other with respect to the X direction, and a distance dy by which the centers 3a are separated from each other with respect to the Y direction. Since the lens element 9 has a predetermined curvature and is disposed corresponding to the LED element 3, when the distance (dx, dy) by which the plurality of LED elements 3 are separated from each other decreases, the lens elements 9 interfere with each other. FIG. 6 is a perspective view illustrating another configuration example of the lens element 9. When the separation distance (dx, dy) between the centers 3a of the LED elements 3 decreases and the separation distance between the vertexes 9a of the lens elements 9 decreases, as illustrated in FIG. 6, the formation region of the lens elements 9 decreases with respect to the direction parallel to the XY plane. More specifically, the length b1 of the lens element 9 with respect to the X direction decreases. Although the length b1 with respect to the X direction is illustrated in FIGS. 5A and 6, the same discussion can be applied with respect to the Y direction.

For example, as illustrated in FIG. 6, when the length b1 of the lens element 9 with respect to the LED element 3 decreases, it is conceivable that the heating light L1 incident on the lens element 9 decreases and affects the mode of traveling of the heating light L1 emitted from the LED element 3.

In view of this, in the light source unit 10, an LED density D_{L} defined by Equation (1) below is set to 5 LEDs/cm² or more and 15 LEDs/cm² or less. More specifically, in the present embodiment, the LED density D_{L} in the heating group G1 is in the above range. The LED density D_{L} is obtained by dividing the effective number of the LED elements 3 located within a first region C1 by the area of the first region C1. The first region C1 is defined by virtually connecting centers 3a of the plurality of LED elements 3 that face the lens substrate 7 and are adjacent to each other when viewed in the Z direction (see FIG. 5B).

$$LED density {D}_{L} = effective number of LED elements in first region / area of first region \qquad ( 1 )$$

Here, the “effective number of LED elements 3 in the first region C1” is calculated by adding up the regions where the plurality of LED elements 3 overlap with the first region C1. Such a definition enables consideration of the influence of interference between the plurality of lens elements 9 on the incidence of the heating light L1 from the LED element 3. In the example of FIG. 5B, the effective number of LED elements 3 located inside the first region C1 is four. For example, assuming that dx and dy are 4 mm, the LED density D_{L} is 6.3 LEDs/cm². Based on the above, the LED density D_{L} can be considered as corresponding to the reciprocal of the product of the separation distance dx and the separation distance dy.

The present inventor has studied the placement of the lens element 9 corresponding to each LED element 3, and has found that, when the LED density D_{L} is within the above range, the temperature of the semiconductor substrate can be increased while shortening of the lifetime of the LED elements 3 is suppressed, compared to the conventional configuration in which the lens element 9 is not disposed. This point will be described in detail in the following sections of Verification 1 and Verification 2.

In addition, the present inventor has found that a ratio R1 defined by Equation (2) below is preferably 8.0 or less from the viewpoint of causing the heating light L1 to be incident on the lens element 9 to reduce the divergence angle of the heating light L1 and to more efficiently heat the semiconductor substrate W1. This point will be described in detail in the section of Verification 3 below.

$$Ratio R 1 = length b 1 of lens element 9 / length a 1 of LED element 3 \qquad ( 2 )$$

### [Verification 1]

As described above, as the distance dx and the distance dy decrease, the formation region of the lens element 9 with respect to the LED element 3 decreases. That is, by varying the distance dx and the distance dy, namely the LED density D_{L}, it is possible to vary the formation region of the lens element 9 with respect to the LED element 3. In the present verification, the change in the light receiving rate of the semiconductor substrate W1 of the heating light L1 emitted from the LED element 3 was studied by varying the LED density D_{L}. This will be described as Verification 1. In the present verification, the light receiving rate was defined as a ratio of the light beam reaching the semiconductor substrate W1 to the total light beam, where the total light beam output from the LED element 3 in Lambertian light distribution was defined as 100%.

### [Verification 1]

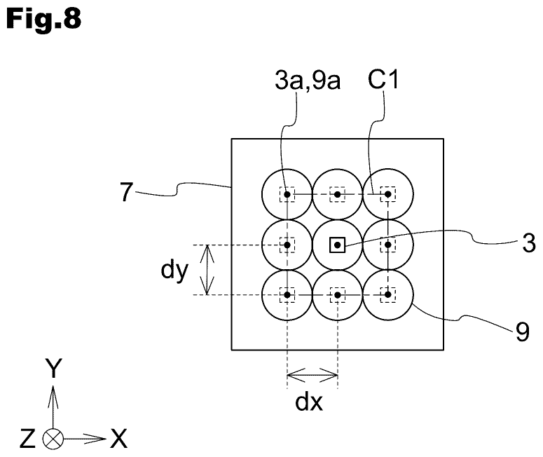

FIGS. 7 and 8 are diagrams illustrating simulation conditions in Verification 1. FIG. 8 corresponds to the drawing when the lens substrate 7 of FIG. 7 is viewed in the Z direction. In the present verification, as illustrated in FIGS. 7 and 8, the lens substrate 7 on which 3×3 lens elements 9 are formed was used.

In the present verification, the change in the light receiving rate of the semiconductor substrate W1 of the heating light L1 emitted from the LED element 3 was verified by changing the separation distance (dx, dy) between each lens element 9 to vary the LED density D_{L}. In the present verification, one LED element 3 was disposed only at a position corresponding to the lens element 9 located at the center. In practice, the LED element 3 is disposed corresponding to each lens element 9, so that the LED density D_{L} was calculated similarly to FIG. 5B assuming that the LED element 3 is disposed corresponding to every lens element 9. In FIGS. 7 and 8, the position of the LED element 3 corresponding to the outer lens element 9 is schematically indicated by a broken line.

This is to simplify the discussion of the light receiving rate. That is, by verifying the change in the light receiving rate of the heating light L1 emitted from the LED element 3 located at the center, it is possible to verify the change in the light receiving rate when the lens elements 9 adjacent to each other interfere. In the present verification, even when a lens element is disposed further outward of the lens element 9 located on the outer side, the light emitted from the central LED element 3 hardly reaches this lens element.

In the present verification, the diameter of the semiconductor substrate W1 was set to 20 mm, and the distance between the semiconductor substrate W1 and the LED element 3 with respect to the Z direction was set to 80 mm. The size of the LED element 3 was 1 mm×1 mm, the length b1 of the lens element 9 was 4 mm, and the input current to the LED element 3 was 1 A. Note that the length b1 of the lens element 9 here means the maximum length in a state where the lens element 9 does not interfere with other lens elements 9.

### [Result of Verification 1]

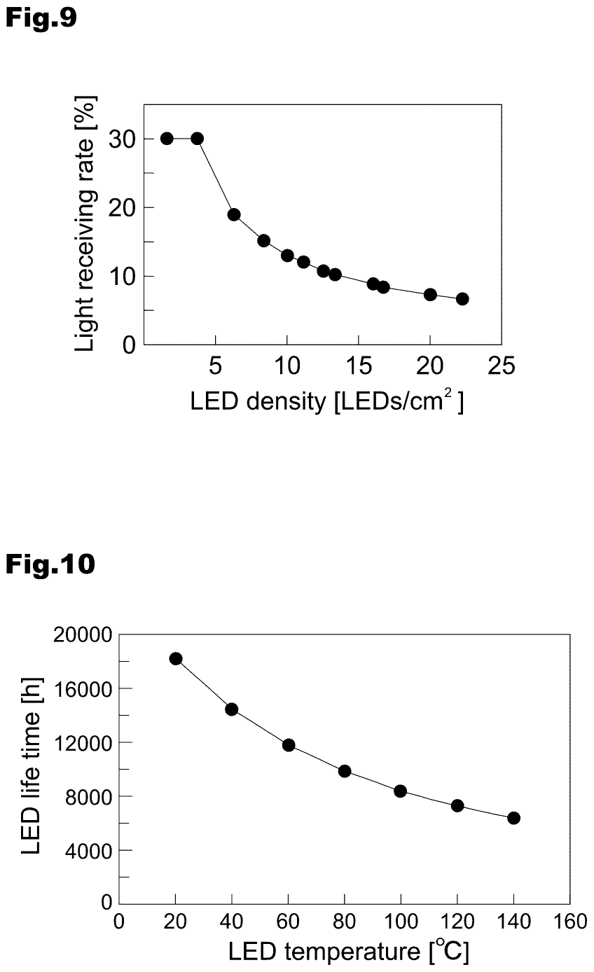

FIG. 9 is a graph illustrating a result of Verification 1. In FIG. 9, the horizontal axis represents the LED density D_{L}, and the vertical axis represents the light receiving rate of the semiconductor substrate W1. As illustrated in FIG. 9, it was shown that the light receiving rate is constant in a range in which the LED density D_{L} is 4 LEDs/cm² or less. This result shows that, in the present verification, the lens elements 9 are separated from each other in the range in which the LED density D_{L} is 4 LEDs/cm² or less, and the formation region of the lens elements 9 does not change. That is, it was shown that the change in the LED density D_{L} has a small influence on the light receiving rate in the range in which the LED density D_{L} is 4 LEDs/cm² or less.

On the other hand, in a range in which the LED density D_{L} was 5 LEDs/cm² or more, the light receiving rate decreased as the LED density D_{L} increased. This is considered to be because, as the LED density D_{L} increased, the separation distance between the vertexes 9a of the lens elements 9 decreased, and the formation region of the lens element 9 with respect to the LED element 3 decreased. That is, it is considered that in the heating light L1 incident on the portion where each lens element 9 interferes with each other, the light directed to the semiconductor substrate W1 decreases.

According to FIG. 9, when the LED density D_{L} exceeded 4 LEDs/cm², the light receiving rate significantly decreased. Then, it can be seen that the light receiving rate decreases as the LED density D_{L} increases, and the decrease in the light receiving rate becomes smaller when the LED density D_{L} is 20 LEDs/cm² or more. This is considered to be because, when the LED density D_{L} was 20 LEDs/cm² or more, the interference between the lens elements 9 increased, and the light incident on the lens elements 9 decreased. Then, when the LED element 3 and the lens element 9 are disposed to face each other, the LED density D_{L} is preferably 20 LEDs/cm² or less.

### [Verification 2]

Verification 1 suggested that, when the lens element 9 is disposed with respect to the LED element 3, the LED density D_{L} is preferably in a range of more than 4 LEDs/cm² and 20 LEDs/cm² or less. Therefore, in the present verification, the influence of disposing the lens element 9 with respect to the LED element 3 was compared and verified on the basis of the LED density D_{L} of 20 LEDs/cm², which is the highest in this range. That is, in the present verification, an achieved temperature T_{W} of the semiconductor substrate W1 and the lifetime L_{T} of the LED were verified in a reference example in which the LED elements 3 were arranged such that the LED density D_{L} was 20 LEDs/cm² while the lens elements 9 were not disposed, and in each example in which the LED density D_{L} was decreased while the lens elements 9 were disposed.

### Example 1

The present verification was performed under the simulation conditions described with reference to FIGS. 7 and 8, similarly to Verification 1.

In Example 1, the LED density D_{L} was set to 5 LEDs/cm², and a maximum temperature Tⱼ of the LED element 3 and the achieved temperature T_{W} of the semiconductor substrate W1 in that case were verified. The lifetime L_{T} of the LED element 3 was calculated based on the maximum temperature Tⱼ of the LED element 3.

The lifetime L_{T} depends on the LED temperature Tⱼ according to the Arrhenius equation shown in Equation (3) below. Since the lifetime L_{T} when the light output is deteriorated depends on a reaction rate K, Equation (4) below is obtained by taking the reciprocal of Equation (3) below. In Equations (3) and (4) below, K represents a reaction rate, A and B represent constants, Ea represents activation energy, k represents the Boltzmann constant, and T represents an absolute temperature.

$$[ Math 1 ]$$

$$K = A \cdot exp ( - \frac{{E}_{a}}{kT} ) \qquad ( 3 )$$

$$L = B \cdot exp ( - \frac{{E}_{a}}{kT} ) \qquad ( 4 )$$

When the time until the illuminance of the LED element 3 decreases to 85% is taken as the lifetime L_{T} based on Equation (4) above, FIG. 10 is obtained. FIG. 10 is a graph illustrating a relationship between the maximum temperature Tⱼ of the LED and the lifetime L_{T} of the LED. By using FIG. 10, the lifetime L_{T} can be obtained based on the maximum temperature Tⱼ of the LED.

### Example 2

The verification was performed under the same conditions as in Example 1, except that the LED density D_{L} was set to 10 LEDs/cm².

### Example 3

The verification was performed under the same conditions as in Example 1, except that the LED density D_{L} was set to 15 LEDs/cm².

### Example 4

The verification was performed under the same conditions as in Example 1, except that the LED density D_{L} was 10 LEDs/cm² and the input current to the LED element 3 was set to 1.5 A.

### Reference Example 1

The verification was performed under the same conditions as in Example 1, except that the LED elements 3 were arranged such that the LED density D_{L} was 20 LEDs/cm², and the lens substrate 7 and the lens elements 9 were not disposed. To be sure, the LED density D_{L} of Reference Example 1 was obtained by dividing the effective number of LED elements located within the first region, formed by virtually connecting the centers of the LED elements, by the area of the region. That is, the LED density D_{L} can be defined in the same manner as in Example 1, except that the lens substrate 7 is not disposed.

### [Result of Verification 2]

Table 1 below is a graph showing the results of Verification 2. In Table 1, the maximum temperature Tⱼ of the LED and the achieved temperature T_{W} of the semiconductor substrate W1 obtained in each example and reference example, and the lifetime L_{T} of the LED obtained based on the maximum temperature Tⱼ are shown.

TABLE 1

| | | | | | Reference |
|---|---|---|---|---|---|
| | Example | Example | Example | Example | Example |
| | 1 | 2 | 3 | 4 | 1 |
| LED density | 5 | 10 | 15 | 10 | 20 |
| D_{L} | | | | | |
| [LEDs/cm²] | | | | | |
| Input current | 1 | 1 | 1 | 1.5 | 1 |
| [A] | | | | | |
| Maximum | 35 | 50 | 60 | 70 | 70 |
| temperature | | | | | |
| Tⱼ | | | | | |
| [° C.] | | | | | |
| LED lifetime | 15000 | 13000 | 13000 | 11000 | 11000 |
| L_{T} | | | | | |
| [h] | | | | | |
| Achieved | 500 | 600 | 550 | 650 | 500 |
| temperature | | | | | |
| T_{W} | | | | | |
| [° C.] | | | | | |

According to Table 1, in Reference Example 1 in which the lens substrate 7 was not disposed, the LED maximum temperature Tⱼ was 70° C., and the LED lifetime L_{T} was 11000 hours. In contrast, in Example 1, heating of the semiconductor substrate W1 comparable to that in Reference Example 1 could be achieved while the LED maximum temperature Tⱼ was suppressed to 35° C. That is, in Example 1, a result was obtained that the lifetime L_{T} of the LED element was longer than that in Reference Example 1 while heating comparable to that in Reference Example 1 was achieved.

This is considered to be because, in Example 1, since the lens element 9 was disposed to face the LED element 3, the divergence angle of the heating light L1 emitted from the LED element 3 was reduced, resulting in a decrease in the heating light L1 traveling in a direction different from that toward the semiconductor substrate W1. That is, in Example 1, the heating light L1 emitted from the LED element 3 was directed toward the semiconductor substrate W1 by the lens element 9, resulting in efficient irradiation with the heating light L1.

In view of the fact that, in Example 1 in which the LED density D_{L} was set to 5 LEDs/cm², heating of the semiconductor substrate W1 similar to that in Reference Example 1 could be achieved, it can be said that the LED density D_{L} is preferably at least 5 LEDs/cm². That is, when the LED density D_{L} is in the range of 4 LEDs/cm² or less, it is conceivable that the number of LEDs arranged on the LED substrate 5 is reduced in the first place, and the heating light for the semiconductor substrate W1 tends to be insufficient.

In Examples 2 and 3, the LED density D_{L} was made larger than that in Example 1, so that the achieved temperature T_{W} of the semiconductor substrate W1 was increased. Moreover, in both Examples 2 and 3, despite the increase in the achieved temperature T_{W} of the semiconductor substrate W1, the maximum temperature Tⱼ of the LED element is lower than the result of Reference Example 1. That is, in Examples 2 and 3, the achieved temperature T_{W} of the semiconductor substrate W1 was increased while the lifetime L_{T} of the LED element was extended beyond that in Reference Example 1.

In addition, in Example 4, the input current to the LED element was increased, causing a higher achieved temperature T_{W} of the semiconductor substrate W1 than in Example 2. Also in this case, the LED maximum temperature Tⱼ is equal to that in Reference Example 1. That is, in Example 4, it was shown that the achieved temperature T_{W} of the semiconductor substrate W1 can be increased while shortening of the lifetime of the LED element is suppressed.

The above results show that the semiconductor substrate W1 can be efficiently irradiated with the heating light L1 emitted from the LED element 3 by disposing the lens element 9 facing the LED element 3. As a result, it is possible to lower the LED density D_{L} and increase the temperature of the semiconductor substrate while suppressing shortening of the lifetime of the LED element, compared to the conventional configuration in which the lens element 9 is not disposed.

Considering the results of the present Verification 2 together with Verification 1, the LED density D_{L} is preferably 5 LEDs/cm² or more and 15 LEDs/cm² or less.

### [Verification 3]

In the above, the verification was performed with the size of the LED element 3 set to 1 mm×1 mm, and the maximum length of the lens element 9 set to 4 mm. In this case, the ratio R1 is 4. Here, in view of the light receiving rate of the semiconductor substrate W1, for example, it seems preferable to reduce the LED element 3 and increase the ratio R1. However, a decrease in the size of the LED element 3 means a decrease in the amount of light emitted from the LED element 3. That is, it can be said that the ratio R1 affects the amount of heating light L1 received that is input to the semiconductor substrate W1. Here, the amount of received light corresponds to the amount of heat input to the semiconductor substrate W1 by the heating light L1, and can be defined by the product of the light receiving rate of the semiconductor substrate W1 and the area of the LED element 3. With this definition, it is possible to consider a change in the amount of light emitted from the LED element 3 when the length of the LED element 3 is changed. In the present verification, the influence on the amount of received light by the semiconductor substrate W1 has been verified by varying the ratio R1, and thus, will be described below.

Specifically, in the present verification, a change in the amount of received light with respect to the ratio R1 was verified by performing a simulation in which the length b1 of the lens element 9 was set to 4 mm and the length a1 of the LED element 3 was varied. Similarly, by setting the length b1 of the lens element 9 to 6 mm and varying the length a1 of the LED element 3, the change in the amount of received light with respect to the ratio R1 was verified.

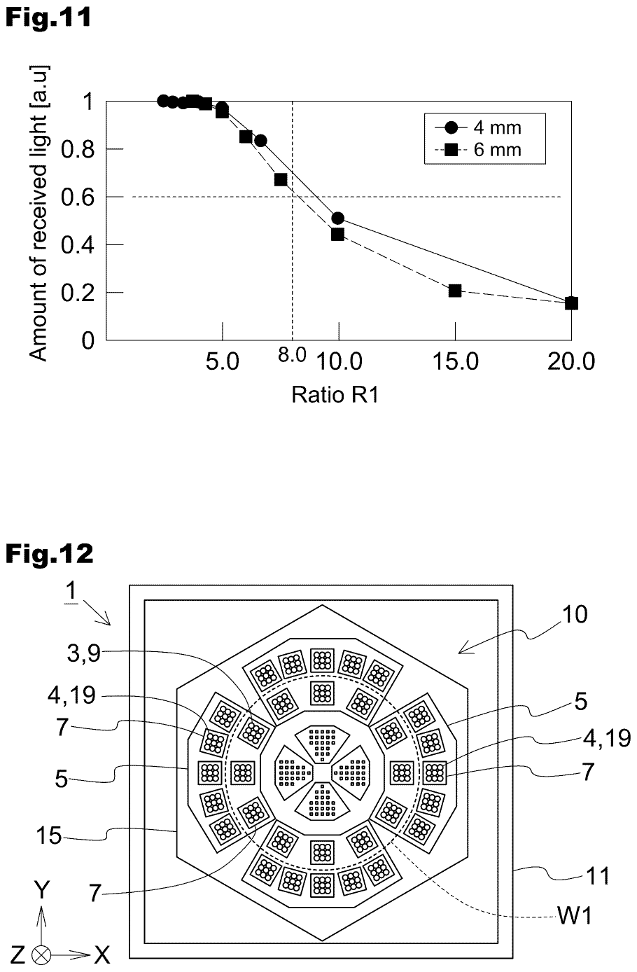

FIG. 11 is a graph illustrating a result of Verification 3. In FIG. 11, the horizontal axis represents the ratio R1, and the vertical axis represents the amount of received light. In FIG. 11, the amount of received light is shown normalized. As illustrated in FIG. 11, it can be seen that the amount of received light decreases as the ratio R1 increases. This is because, although reducing the size of the LED element 3 relative to the lens element 9 increases the light receiving rate, the reduction in the light emission of the LED element 3 has a larger effect. As can be seen from FIG. 11, when the ratio R1 is in the range of 8.0 or less, the amount of received light can be maintained at at least 60%. In view of this, the ratio R1 is preferably 8.0 or less. From the viewpoint of increasing the amount of received light, the ratio R1 is more preferably 5.0 or less.

Typically, in view of the fact that the length b1 of the lens element 9 is larger than the length a1 of the LED element 3, the ratio R1 preferably exceeds 1.0. In addition, for example, the design of the fine lens element 9 tends to cause an increase in cost. In view of this, the ratio R1 is more preferably 2.0 or more, particularly preferably 4.0 or more.

As illustrated in FIG. 11, the amount of received light shows a similar tendency with respect to the ratio R1 when the length b1 of the lens element 9 was 4 mm and when the length b1 was 6 mm. That is, from the viewpoint of increasing the amount of received light, the length b1 of the lens element 9 and the length a1 of the LED element 3 are not limited, and it is suitable to discuss using the ratio R1.

### [Summary of Verifications]

The above verifications show that, by disposing the lens element 9 corresponding to the LED element 3, the semiconductor substrate W1 can be heated at a higher temperature while shortening of the lifetime of the LED element 3 is suppressed, compared to the conventional configuration in which the lens element 9 is not disposed. That is, in order to irradiate the semiconductor substrate W1 with a large amount of heating light, a method of additionally disposing an LED element by reducing the separation distance between the LED elements is conceivable, but in this method, the temperature of the LED elements tends to increase, leading to shortening of the lifetime of the LED elements. In contrast, by disposing the lens element 9 facing the LED element 3, it is possible to irradiate the semiconductor substrate W1 with a larger amount of heating light L1, and it is possible to heat the semiconductor substrate W1 at a higher temperature while suppressing shortening of the lifetime of the LED element due to the reduction in the separation distance of the LED element.

When the lens element 9 is disposed with respect to the LED element 3, the LED density D_{L} of the LED element 3 disposed to face the lens substrate 7 is preferably 5 LEDs/cm² or more and 15 LEDs/cm² or less. Moreover, from the viewpoint of causing the heating light L1 emitted from the LED element 3 to be incident on the lens element 9, the ratio R1 of the length a1 of the LED element 3 to the length b1 of the lens element 9 is suitably 8.0 or less.

In view of the above verification results, by disposing the lens element 9 corresponding to the LED element 3, the divergence angle of the heating light L1 is reduced, and the heating light L1 traveling in a direction different from that toward the semiconductor substrate W1 is reduced, resulting in an increase in the temperature of the semiconductor substrate W1. In the above verification, the diameter of the semiconductor substrate W1 was set to 20 mm, and the distance between the semiconductor substrate W1 and the LED element 3 with respect to the Z direction was set to 80 mm. However, the achieved temperature of the semiconductor substrate W1 can be increased when the heating light L1 traveling in a direction different from that toward the semiconductor substrate W1 is reduced by the lens element 9, and the present invention is not limited to the above simulation conditions.

According to the above verification, it can be understood that the configuration described in the first embodiment makes it possible to increase the temperature of the semiconductor substrate while suppressing shortening of the lifetime of the LED element, compared to the related art. That is, according to the first embodiment, it is possible to achieve a light source unit and an optical heating apparatus capable of heating the semiconductor substrate W1 at a higher temperature while suppressing shortening of the lifetime of the LED element 3, compared to the conventional configuration in which the lens element 9 is not disposed.

### [Modifications]

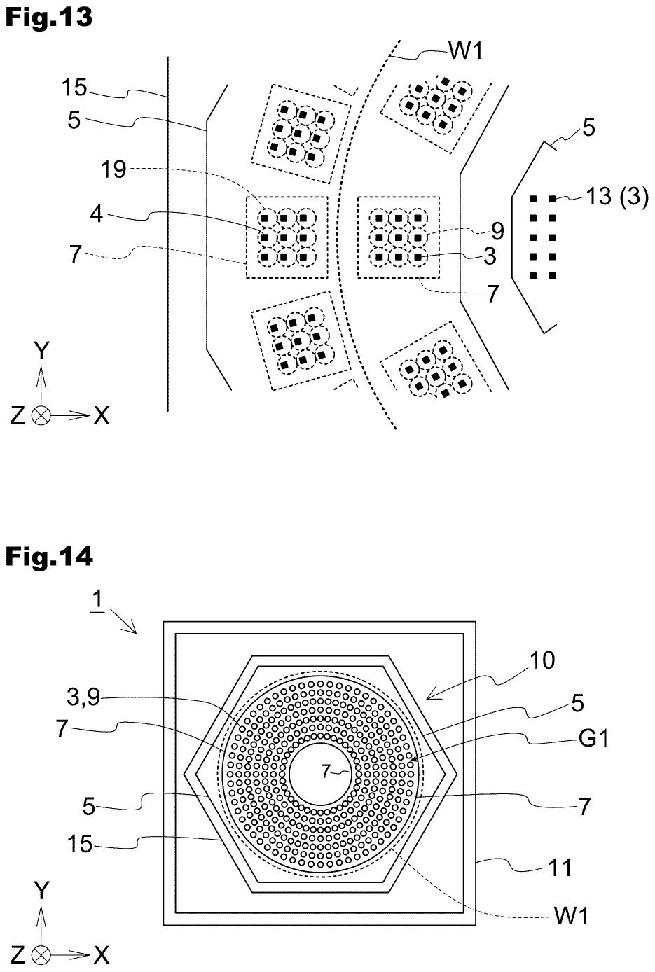

Hereinafter, modifications of the optical heating apparatus 1 and the light source unit 10 will be described.
<1> FIG. 12 is a view illustrating a modification of the light source unit 10 in accordance with FIG. 2, and FIG. 13 is an enlarged view of a part of FIG. 12. In FIGS. 12 and 13, the position of the semiconductor substrate W1 is schematically indicated by a broken line. In the above, the LED element 3 included in the light source unit 10 has been described as being disposed in the region facing the semiconductor substrate W1. However, as illustrated in FIG. 13, the light source unit 10 may include an LED element 4 disposed in a region outside the semiconductor substrate W1 when viewed in the Z direction.

In FIGS. 12 and 13, as described in the first embodiment, the lens element 9 is disposed corresponding to each of the plurality of LED elements 3 facing the peripheral end portion of the semiconductor substrate W1. Similarly, a lens element 19 is disposed corresponding to the LED element 4. The configuration of the lens element 19 is similar to that of the lens element 9.

Here, in the present modification, from the viewpoint of facilitating the heating light L1 emitted from the LED element 4 disposed in a region outside the semiconductor substrate W1 to be directed toward the semiconductor substrate W1, the lens element 19 disposed corresponding to the LED element 4 may be disposed such that its vertex approaches the center of the semiconductor substrate W1 from the optical axis of the LED element 4. Specifically, with respect to the direction toward the center of the semiconductor substrate W1, the amount of offset between the optical axis of the LED element 4 and the central axis of the lens element 19 may be set to 20% or more and 50% or less of the length of the LED element 4. As an example, when the LED element 4 has a size of 1 mm square, the amount of offset is set to 0.4 mm.

As for the LED density D_{L} and the ratio R1, the same discussion as that for the LED element 3 can be applied to the LED element 4 disposed in the region outside the semiconductor substrate W1.
<2> In the above, it has been described that the light source unit 10 is disposed on the +Z side of the semiconductor substrate W1, and the light source unit 10 emits the heating light L1 in the −Z direction, but this is optional. For example, the light source unit 10 may emit the heating light L1 in the +Z direction, and the semiconductor substrate W1 may be disposed on the +Z side of the light source unit 10.
<3> In the above, the lens element 9 has been described as being formed on the −Z side of the lens substrate 7 and having a convex shape on the −Z side. However, from the viewpoint of reducing aberration and irradiating the semiconductor substrate W1 with the heating light L1 more accurately, the lens element 9 may be formed on the +Z side of the lens substrate 7 and may have a convex shape on the +Z side.
<4> The inclusion of the chamber 11 in the optical heating apparatus 1 is optional. For example, the chamber 11 is unnecessary when the semiconductor substrate W1 is heated in an air atmosphere, such as in a case where it is not necessary to replace the periphery of the semiconductor substrate W1 with a process gas such as nitrogen. That is, the present invention is not limited to whether or not the semiconductor substrate W1 and the light source unit 10 are accommodated in the chamber 11.
<5> FIG. 14 is a view illustrating another modification of the light source unit 10 in accordance with FIG. 2. In the above, the light source unit 10 has been described as including the plurality of heating groups G1. However, in the present invention, this is optional, and for example, as illustrated in FIG. 14, all the LED elements 3 may be arranged to overlap with one lens substrate 7 on the LED substrate 5, and the light source unit 10 may include one heating group G1.

In FIG. 14, as described with reference to FIG. 3, in the heating group G1, the LED elements 3 may be arranged close to each other.
<6> The configuration according to the present invention is not limited to the illustrated configurations. The configurations of the above embodiment and modifications can be achieved in combination as appropriate.

### DESCRIPTION OF REFERENCE SIGNS

1 Optical heating apparatus
3, 4, 13 LED element
5 LED substrate
7 Lens substrate
9, 19 Lens element
10 Light source unit
11 Chamber
12 Support unit
15 Heat sink
20 Support member
21 Adhesive

What is claimed is:

1. A light source unit that irradiates a semiconductor substrate with light to perform heat treatment on the semiconductor substrate, the light source unit comprising:
a plurality of light-emitting diode (LED) elements that emit the light in a first direction;
an LED substrate on which the plurality of LED elements are arranged;
a lens substrate disposed to face the plurality of LED elements with respect to the first direction; and
a plurality of lens elements formed in a convex shape on the lens substrate at positions corresponding respectively to the LED elements, each of the lens element being configured to reduce a divergence angle of the light emitted from the corresponding LED element,
wherein
an LED density is 5 LEDs/cm² or more and 15 LEDs/cm² or less, the LED density being obtained by dividing an effective number of the LED elements located within a first region by an area of the first region, the first region being defined by virtually connecting centers of the plurality of LED elements that face the lens substrate and are adjacent to each other when viewed in the first direction, and
a ratio, obtained by dividing a length of the lens element corresponding to the LED element by a length of the LED element with respect to a direction parallel to a plane orthogonal to the first direction, is 8.0 or less.

2. The light source unit according to claim 1, further comprising
a support member that is disposed on the LED substrate, extends beyond the LED element with respect to the first direction, and supports the lens substrate,
wherein the lens substrate is fixed to the support member via an adhesive.

3. The light source unit according to claim 1, wherein each of the lens elements has a convex shape on a side opposite to the LED element.

4. The light source unit according to claim 2, wherein each of the lens elements has a convex shape on a side opposite to the LED element.

5. The light source unit according to claim 3, wherein a separation distance between the LED substrate and the lens substrate with respect to the first direction is 2 mm or less.

6. The light source unit according to claim 4, wherein a separation distance between the LED substrate and the lens substrate with respect to the first direction is 2 mm or less.

7. The light source unit according to claim 1, including a plurality of heating groups each including the plurality of LED elements arranged close to each other,
wherein, in at least one of the heating groups, the LED density is 5 LEDs/cm² or more and 15 LEDs/cm² or less, and the ratio is 8.0 or less.

8. The light source unit according to claim 2, including a plurality of heating groups each including the plurality of LED elements arranged close to each other,
wherein, in at least one of the heating groups, the LED density is 5 LEDs/cm² or more and 15 LEDs/cm² or less, and the ratio is 8.0 or less.

9. The light source unit according to claim 1, wherein at least one of the LED elements is disposed to face a peripheral end portion of the semiconductor substrate.

10. The light source unit according to claim 2, wherein at least one of the LED elements is disposed to face a peripheral end portion of the semiconductor substrate.

11. An optical heating apparatus comprising the light source unit according to claim 1.
